(19) United States
(12) Patent Application Publication
(10) Pub. No.: US 2023/0024610 A1
(43) Pub. Date: Jan. 26, 2023

(54) RETRACTABLE MECHANICAL DEVICE AND METHOD FOR CLEANING TUBULAR STRUCTURES AND INSTALLING SENSOR/TRANSDUCER ELEMENTS ON THE INSIDE WALL THEREOF

(71) Applicant: Petróleo Brasileiro S.A. - Petrobras, Rio de Janeiro (BR)

(72) Inventors: Edgard Poiate Junior, Niterói (BR); Giuseppe Barbosa Guimarães, Rio de Janeiro (BR); Renato Seixas Da Rocha, Rio de Janeiro (BR); Euclides Domingues De Moura Neto, Nilópolis (BR)

(21) Appl. No.: 17/788,080

(22) PCT Filed: Dec. 16, 2020
(86) PCT No.: PCT/BR2020/050554

§ 371 Date: Jun. 22, 2022

(30) Foreign Application Priority Data
Dec. 23, 2019 (BR) 10 2019 027785 8

(51) Int. Cl. B24B 5/40; B08B 9/045

(52) U.S. Cl. CPC B24B 5/40; B08B 9/045; G01N 3/06

(57) ABSTRACT

The present invention provides a device and method for installing sensor/transductor elements on the inside wall of tubular structures, comprising a step of cleaning the inside of a duct and a step of installing the sensor/transductor. The mechanical device that is the subject matter of the present invention comprises four articulated arms (2), each one being coupled at the ends thereof to through-slits (23) in prismatic components (21) and the latter coupled to control elements (1) and (31) which by means of the threaded axial through-holes (24) thereof are screwed to the power screw axes (30) and (32) and by actuating same by rotating the extension tube (5) cause radial movement of the articulated arms (2), said retractable mechanical device also comprising centralizing elements (34) composed of at least 4 spring shafts (35).

### FIELD OF THE INVENTION

The present invention provides a device and a method for carrying out the installation of sensor/transductor elements on the inside wall of tubular structures, comprising a step of cleaning the surface of this wall and a step of positioning and fixing the sensor/transductor.

### Invention History

The installation of sensor/transductor elements, such as electrical strain gauges (deformation measurement elements) on inside walls of tubular structures to obtain mechanical parameters of resistance and deformability and or for the validation of analytical and numerical analysis of tubular structures subjected to collapse loads presents a high degree of difficulty.

In the current state of the art, the test method available for determining the external pressure load of collapse of a tubular structure consists of fixing a segment of tube by the region of its ends inside a watertight hydrostatic chamber wherein the sealing occurs by compressing the outer walls of the tube ends by elastomeric or metallic rings. The tube is then subjected to increasing hydrostatic loading over time until it collapses and the external collapse pressure is measured.

In addition, under these test conditions the only variables that can be measured are the evolution of pressure and temperature of the water introduced in the space between the external region of the tube to be tested and the internal part of the hydrostatic collapse chamber (confined region).

Thus, the measurement of important mechanical parameters such as deformations and displacements that occur in the tube walls is not performed during the current test method.

Document U.S. Pat. No. 5,442,665 A describes a method for monitoring the vibration induced by a flow in a pressure vessel which comprises connecting a vibration sensor to a transmission cable, and fixing the vibration sensor inside a cylindrical element, where the vibration sensor can be a strain gauge fixed to a guide tube, and the latter is welded inside the tube wherein the measurements will be carried out.

Document U.S. Pat. No. 3,737,886 A describes an apparatus for monitoring the flow of liquid which comprises two strain gauges arranged one above the other on the inside wall of a tube wherein they are fixed by means of resin or adhesive. The document also describes that the strain gauges can be fixed to the wall of the tube together with an internal cover of the tube or else fixed with the aid of holes made in the tube.

Document CN 202177482 U is directed to a device that comprises a strain gauge fixed to the inside wall of a duct in order to provide a high precision in the measurements performed by the strain gauge.

Document EP 927338 B1 is directed to a Coriolis flow meter that comprises, among other elements, a strain gauge fixed to the flow duct so that the strain gauge is able to indicate deformations in the flow duct to indicate the internal pressure of the duct. However, the document does not provide any details about fixing the strain gauges in the ducts, wherein the strain gauge is positioned on the external wall of the duct.

Document JP 3220434 A discloses a method for measuring residual stress in a structural tubular body, further disclosing a system comprising an outer ring, an inner ring and an intermediate ring forming the structural body, wherein a strain gauge is positioned on the outer surface of the outer ring to perform residual stress measurements after all elements are fitted.

Document EP 2437040 A1 discloses a system that allows the measurement of small pressure variations in a tube with the use of strain gauges where they are applied to the external wall of the tube wherein the pressure measurement will be carried out, wherein a second tube (cut in half) is used to assist in the installation of strain gauges, as well as to prevent bubble formation.

As will be observed, none of the documents mentioned above disclose the device and method for installing sensor/transductor elements, such as strain gauges as proposed by the present invention.

### BRIEF DESCRIPTION OF THE DRAWINGS

The present invention will be discussed in more detail below with reference to the figures, wherein:

FIG. 1 illustrates the assembly of the retractable mechanical device of the present invention in the closed (FIG. 1a) and opened (FIG. 1b) positions;

FIG. 2 also illustrates the assembly of the retractable mechanical device of the present invention in the closed (FIG. 2a) and opened (FIG. 2b) positions, but in a view from the opposite end of the device, and coupled to an extension axis and tube, ready for introduction into tubular structures of different dimensions;

FIG. 3 illustrates in the front and side views and in two isometric perspectives (FIGS. 3a to 3d) the detail of the work table for fixing the cleaning system on the inside wall of the tubular structure, or for fixing the installation system of sensor/transductors therein;

FIG. 4 shows details of two possible assemblies on the work table, the cleaning system for the inside wall of the tubular structure (FIGS. 4a and 4c), and the system for installing sensors/transductors (FIGS. 4b and 4d);

FIG. 5 illustrates in the front and side views and in two isometric perspectives (FIGS. 5a to 5d) the detail of an articulated arm composed of two mechanisms of four bars coupled by the work table (3c), and which is responsible for its support, and by transforming movement in the axial direction into movement in the transverse direction of the device;

FIG. 6 illustrates in the front and side views and in four perspectives the detail of the control element that is responsible for adjusting the device geometry to the internal dimension of the tubular structure, and also for the compression force of the cleaning or installing systems of sensor/transductor against the inside wall of the tubular structure;

FIG. 7 illustrates the front, side and perspective views of the set of four articulated arms of the device, each one with a work table, two mechanisms of four bars, and two control elements;

FIG. 8 illustrates the front, side and perspective views of the centralizing element that is responsible for the static positioning during the sensor/transductor installation operation, and for the dynamic positioning during the cleaning operation;

FIG. 9 illustrates perspective views of the device mounted and coupled to the axis and extension tube with transparency for detailing the couplings.

### DETAILED DESCRIPTION OF THE INVENTION

The present invention relates to a retractable mechanical device to perform the cleaning and installation of sensor/transductor elements on the inside wall of tubular structures.

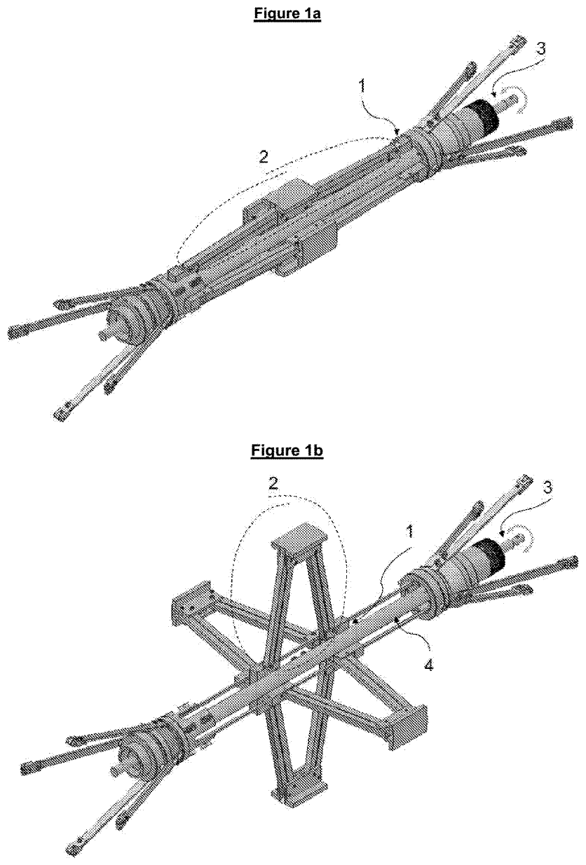

More specifically, the present invention relates to a retractable mechanical device (FIG. 1) especially suitable for accessing the internal section of tubular structures, which comprises a basic structure consisting of four articulated mechanisms called articulated arms (2) that have as a means a power screw axis type system (3) and a tube with four slits offset at 90 degrees (4), which is the main structural element of the device, and in addition, for example, works as an axial guide and transmits torque to the left threaded control element (1). The angular movement of the power screw (3) generates axial linear movement of the control element (1) and movement of the articulated arms (2) in two directions perpendicular to each other. That is, for example, if the articulated arms (2) are in the closed position (FIG. 1a), when the screw axis (3) is turned clockwise, it causes the linear movement of the control elements (1) that radially actuate the articulated arms, which open simultaneously in four positions equidistant from the central axis of the power screw axis (FIG. 1b).

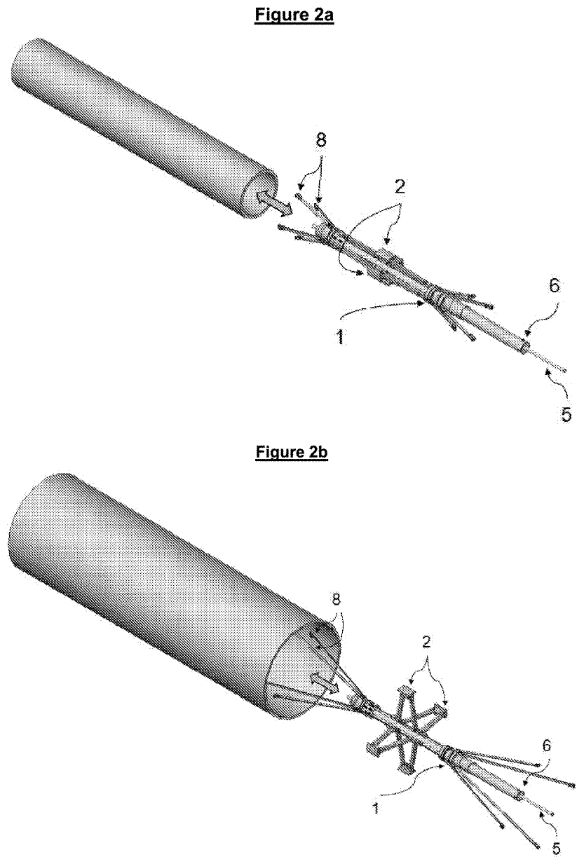

The retractable mechanical device is introduced into a tubular structure (FIG. 2), as exemplified in FIGS. 2a and 2b. The retractable mechanical device is supported by the centralizers (7) by means of spring shafts (8). To access positions far away from the reach of human hands inside the tubular structure, in cleaning operation or when installing the sensor/transductor inside the tubular structure, the device is coupled to an extension axis (5) and an extension tube (6), whose lengths are defined according to the services that will be performed with the device object of the invention.

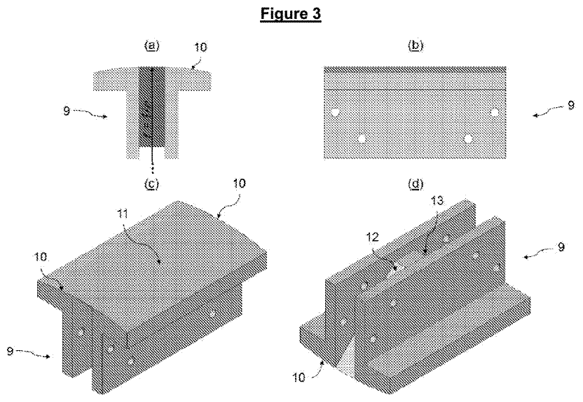

It can be seen in FIG. 3 that the device according to the present invention comprises an articulating structural element named work table (9), with a general shape of a straight prism with a “T” base, equipped with two angled through-slits inclined (13; 12), or slots. The work table (FIG. 3c) has a continuous surface, called support surface (11), which is the place for fixing elements such as elastomer blankets, sandpaper and fabrics, or instruments to be installed such as sensors/transductors and identification tags such as RFID tags. The support surface of the work table is preferably curved (10) following an arc compatible with the services that will be performed with the device object of the invention. For example, one can set the curvature of the domed bearing surface equal to the mean of the curvature function “ρ(r)=1/r” between the minimum and maximum apertures of the device, where “ρ” is the curvature of the bearing surface and “r” the variable opening radius of the device. By calculating the average of the curvature function “ρ_{average}” between the minimum “rₘᵢₙ” and maximum “Rₘₐₓ” openings of the device, it results that “ρ_{average}=(Ln(Rₘₐₓ)−Ln(rₘᵢₙ))/(Rₘₐₓ−rₘᵢₙ)”, where “Ln(x)” is the natural logarithm of “x”.

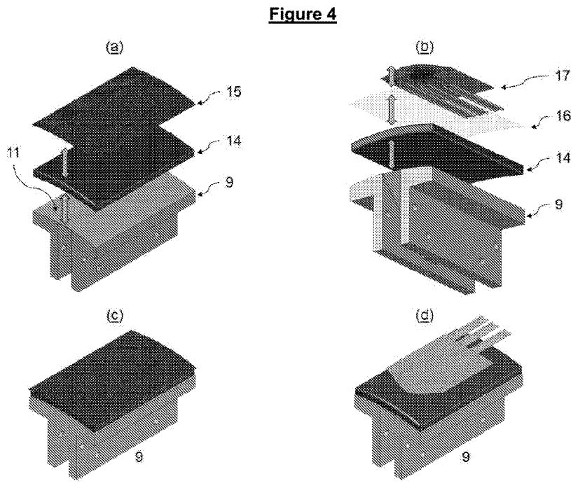

FIGS. 4a and 4c illustrate the assembly of elements for cleaning, such as an elastomer blanket (14) and sandpaper (15) on the support surface (11) of the work table (9). FIGS. 4b and 4d illustrate the assembly of sensor/transductor element (17) in double-sided tape (16) under elastomer blanket (14) on the support surface of the work table (9).

FIG. 5a shows the front view of the articulated arm (2) which is formed by two symmetrical mechanisms of four bars (18) coupled together through the work table (9) by screws (22). The fourth bar of the mechanism is formed by coupling the prismatic component (21) equipped with a through-slit (23) with the bars (19) and (20) by means of screws (22), which act as axes for the free rotation of (18). FIG. 5b shows the side view of (2). FIG. 5c shows the isometric view of the prismatic component (21). FIG. 5d presents the isometric view of the articulated arm (2).

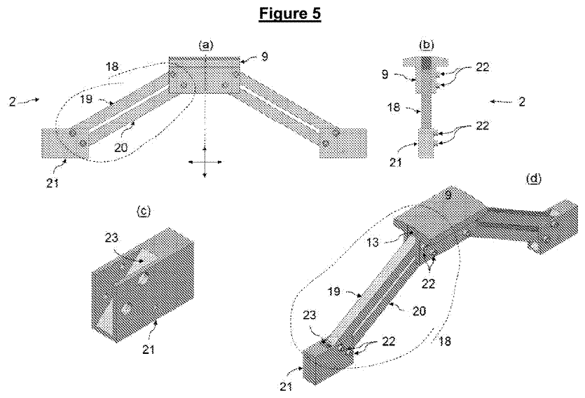

FIG. 6a shows the front view of the control element (1) formed by a cylindrical piece equipped with an left threaded axial through-hole (24) and four longitudinal through-slits offset at 90 degrees (25-26-27-28), FIG. 6b. FIG. 6c shows the isometric view of the control element (1) with emphasis on the threaded hole (29). FIG. 6d illustrates the isometric view of the coupling projection of the four prismatic components (21) to the control element (1) through the threaded hole (29). FIG. 6e shows the isometric view of the assembly of the four-bar mechanism (18) to the control elements (1) and (31) by means of a screw housed in the hole (29).

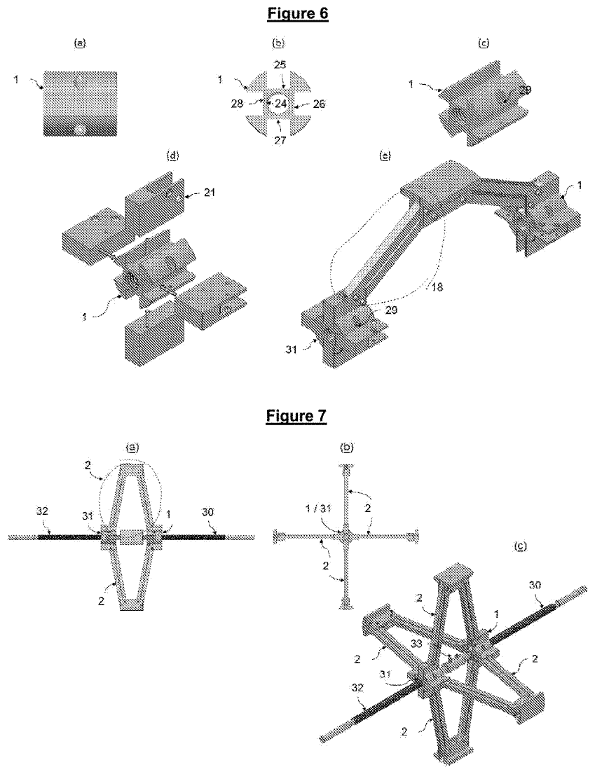

FIG. 7a shows the front view of the articulated arms (2) with one end coupled to the power screw (30), with left thread, through the left thread control elements (1) and the other end coupled to the right thread control (31) and the power screw (32), with right thread. FIG. 7b shows the side view of the assembly formed by the four articulated arms (2) positioned at 0 degrees, 90 degrees, 180 degrees and 270 degrees coupled to the left (1) and right (31) thread control elements. FIG. 7c presents an isometric view showing the coupling of the power screws (30) and (32) to the sleeve with screws (33).

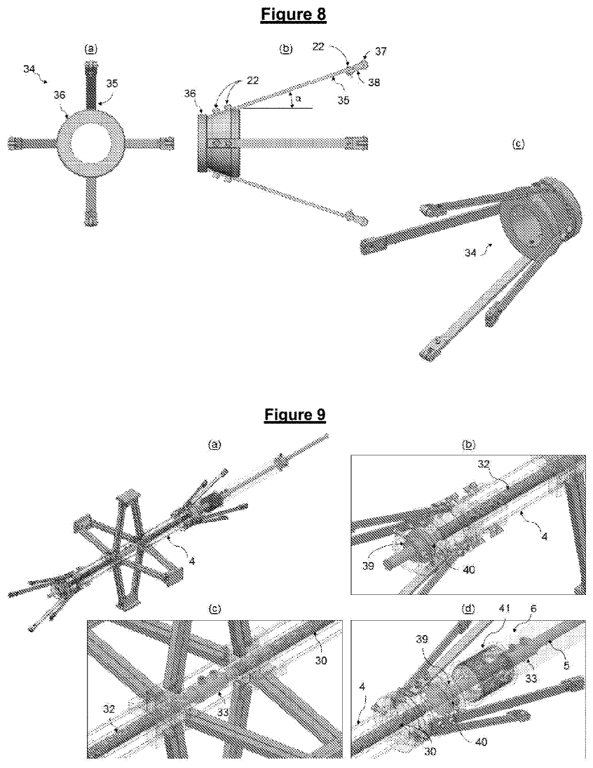

FIG. 8a shows the front view of the centralizing element (34) which is composed of at least four spring shafts (35) coupled to a hollow conical component (36). FIG. 8b shows the side view of the centralizing element (34) which has a rolling or sliding bearing (37) housed in a support (38) coupled to one of the ends of the spring shaft (35) by means of a screw and nut (22). The other end of the spring shaft (35) is coupled to the hollow cone (36), with an angle α between 15 and 75 degrees, by screws (22). FIG. 8c shows the isometric view of the centralizing element (34).

FIG. 9a presents the isometric view of the device completely assembled with elements in transparency, such as the slit tube (4), to show details of the internal couplings of the mechanisms of operation of the same. FIG. 9b shows an enlargement on the front of the device, highlighting the power screw (32) coupled to the support collar (39), which restricts its axial movement and is centered by a bushing (40) coupled to the slit tube (4). FIG. 9c shows an enlargement in the middle region of the device wherein the screw bushing (33) that solidifies the power screws (30) and (32) stands out. FIG. 9d shows an enlargement on the back of the device highlighting the power screw (30) coupled to the support collar (39) that restricts its axial movement and is centered by a bushing (40) coupled to the slit tube (4). And the slit tube (4) is coupled to the extension tube (6) by means of a sleeve (41), in addition to the coupling of the extension axis (5) to the power screw (30).

The retractable mechanical device (FIG. 1) object of the present invention comprises four articulated arms (2), each coupled from their ends to the slots (12) and (13) (FIG. 3) of the two structural elements called elements (1) and (31) (FIG. 7), so that one end of a first articulated arm (2) engages with the internal side walls of the slot (12) and (13) (FIG. 3) of the first control element (1) (FIG. 1), while the other end of a first articulated arm (2) couples to the inside side walls of a slot (12 or 13) of the second control element (31) (FIG. 7); one end of a second articulated arm (2) couples to the inside side walls of the slot (12 or 13) of the first control element (1), while the other end of a second articulated arm (2) couples to the inside side walls of a slot (13) of the second control element (31); and so on, having the embodiment according to FIG. 1. These couplings are such that they allow the relative articulation between the articulated arm (2) and the control elements (1) and (31). A cylindrical bar comprising a threaded screw axis (30) is introduced into the structure, passing through the threaded hole (24) of the first control element (1). Another cylindrical bar comprising a threaded screw axis (32) is introduced into the structure, passing through the threaded hole (24) of the second control element (31). The direction of the threads of the two screw axes (30) and (32) and of the respective control elements (1) and (31) are reversed. Finally, the two screw axes are joined together by means of a sleeve (41) with screws. The centralizing of the device in FIG. 1 in relation to the inside wall of the tube is made by two centralizing elements (34), which are composed of at least four spring shafts (35) that have rolling or sliding bearings at their ends (37), which are in contact with the tube wall, and which, due to their rigidity and dimensions, centralize the tool.

Thus structured the device according to the present invention, from the moment wherein the power screw axes (30) and (32) are turned, they cause the longitudinal movement of the control elements (1) and (31) in a way that, depending on the direction of rotation caused, the control elements (1) and (31) move closer to each other or move away from each other. With the movement of the control elements (1) and (31), these being coupled to the articulated arms (2), cause their radial movement so that with the approach of the control elements (1) and (31) one to the other, causes the work tables (9) of the four articulated arms (2) to move radially away from each other, equidistant from the central axis of symmetry of the mechanism.

The described embodiment of the device leads to the method of cleaning and installing sensor/transductor elements in the inside diameter of tubular structures below.

For the internal cleaning of a pipe and the installation of the sensor/transductor elements, the following steps are carried out:

1—fix sandpaper (15) on the support surfaces (11) of the work tables (9), specifically on the edge (10) of the four articulated arms (2);

2—couple the device to an axis (5) and to an extension tube (6), with a length defined from the distance from the tip of the tube to be cleaned to the region where cleaning will be performed;

3—coupling the other end of the extension tube to rotation means, such as a manual drill, the latter being coupled to a fixed magnetic base, to support the end of the structure (not shown);

4—insert the device into the tube to be cleaned until it reaches the cleaning position;

5—activate the device mechanically through the extension tube (6) to activate the power screws (30) and (32) until the work tables are pressed to the inner radius of the tube and the other end is leveled and fixed;

6—activate the rotation means for sanding/cleaning the inner perimeter;

7—change the sandpaper sequentially from greater to lesser granulation until reaching the necessary cleaning and surface roughness; and, then

8—replace the sandpaper on the work tables (9) with cloths greased with isopropyl alcohol and repeat steps 4 to 6 to clean the tube.

For the installation of the sensor/transductor elements on the inside wall of the tube, an operation that is more complex than the internal cleaning of the tube, the same mechanical device is used, and the steps for installing the sensor/transductor elements comprise:

1—install on the support surface (11), as an elastomer blanket (14) of low rigidity, to function as pads, on the work tables (9);

2—install double-sided tapes (16) over the pads, and;

3—place the sensor/transductor element (17) on the double-sided tape, with the terminals already soldered to the data/energy cable and with glue, for example, cyanoacrylate on its surface to adhere to the inside wall of the tube;

4—place the device inside the tube to be installed using the extension tube (6) up to the pre-defined installation position of the sensor/transductor element (17);

5—activate the device by means of the power screws (30) and (32) until the support elements with the elastomer blankets (14) on the work tables (9) press the sensor/transductor element (17) under pressure, preferably for the minimum gluing time recommended by the glue manufacturer, on the inside of the tube;

6—remove the device from inside the tube, and check the operation of the sensor/transductor elements (17) and protect them, for example, with epoxy resin.

Those skilled in the art will appreciate that the mechanical retractable device according to the present invention may undergo some structural modifications or adaptations, which may provide eventual applications different from those mentioned above. However, such modifications and/or adaptations, as well as the resulting applications, must be seen as within the inventive scope described above and claimed herein.

1. RETRACTABLE MECHANICAL DEVICE, characterized by comprising four articulated arms (2) each one being coupled from their ends to the through-slit (23) of prismatic components (21), and these couple the control elements (1) and (31), which, through their threaded axial through-hole (24) are screwed to the power screw axes (30) and (32), and which, through their actuation by rotation of the extension tube (5) cause radial movement of the articulated arms (2); said retractable mechanical device further comprising centralizing elements (34), composed of at least 4 spring shafts (35).

2. RETRACTABLE MECHANICAL DEVICE, according to claim 1, characterized in that the control elements (1) or (31) comprise a solid three-dimensional structure, formed by the intersection of a cylinder and two shafts forming a cross, wherein the cross and the cylinder share the same geometric center, further, said shafts comprise at each of their four ends slits (25, 26, 27, 28).

3. RETRACTABLE MECHANICAL DEVICE, characterized in that said articulated arm (2) comprises two arms that are four-bar symmetrical mechanisms (18), wherein said mechanisms are formed by a pair of bars (19) and (20) arranged parallel to each other, and being coupled, through the ends of the shafts to the inside side walls of slits (12 and 13) and through-slit (23), of a control element (1 or 31) and of an articulated structural element called work table (9) by means of screws (22); said coupling allowing the relative articulation between the arms (2) and the control element (1 and 31) thus forming an articulation between the two arms (2).

4. RETRACTABLE MECHANICAL DEVICE, according to claim 3, characterized in that the work table (9) comprises a solid rectangular structure provided with two slits (12, 13) on its sides, and further comprising a support surface (11) coupled in its upper portion.

5. RETRACTABLE MECHANICAL DEVICE, according to claim 4, characterized in that the support surface (11) has a flat or domed surface (10).

6. RETRACTABLE MECHANICAL DEVICE, according to claim 4, characterized in that the support surface (11) comprises an element to come into contact with the inside wall of tubular structures.

7. RETRACTABLE MECHANICAL DEVICE, according to claim 6, characterized in that the equipment comprises one of sandpaper (15), fabric or double face (16), elastomer blanket (14) and sensor/transductor (17).

8. RETRACTABLE MECHANICAL DEVICE, according to claim 1, characterized in that when turning the power screw axes (30) and (32) a longitudinal movement of the control elements (1) and (31) is provided because of being coupled to the articulated arms (2), causing their radial movement, so that with the approach of the control elements (1) and (31) they occur from one another; and with the control elements (1) and (31) moving away from each other, the articulating elements (2) of the four articulated arms radially approach each other, equidistantly from the central axis.

9. METHOD FOR CLEANING AND INSTALLING SENSORS/TRANSDUCTORS ELEMENTS IN THE INSIDE DIAMETER OF TUBULAR STRUCTURES, characterized in that cleaning comprises the following steps:
(a) installing sandpaper (15) on the support surface (11) of the work table (9) of the four articulated arms (2);
(b) coupling the device to an extension tube (6) and axis (5);
(c) coupling the other end of the extension tube (6) to rotation means;
(d) inserting the device into the tube to be cleaned until it reaches the position where it is desired to be cleaned;
(e) mechanically actuating the device by means of the extension tube (6) to actuate the power screws (30) and (32) until the support elements are pressed to the inside radius of the tube and the other end is leveled and fixed;
(f) actuating the rotating means, and the tube is sanded on its inside perimeter;
(g) changing the sandpaper (15) sequentially from higher to lower granulation until cleaning and surface roughness are achieved; and, then
(h) replacing the sandpaper on the work tables (9) with cloths greased with isopropyl alcohol and cleaning the tube using the device.

10. METHOD FOR CLEANING AND INSTALLING SENSOR/TRANSDUCTOR ELEMENTS IN THE INSIDE DIAMETER OF TUBULAR STRUCTURES, characterized by the installation of sensor elements comprising the following steps:
(a) installing on the support surface (11) under low rigidity elastomer blankets (14);
(b) installing double-sided tape over the pads, and
(c) placing the sensor/transductor under the double-sided tape (16);
(d) placing the device inside the tube to be installed using the extension tube (6) to the pre-defined installation position of the sensor/transductor element (17);
(e) actuating the device by means of the power screws (30) and (32) until the support elements with the elastomer blankets (14) on the work tables (9) press the sensor/transductor element (17) under pressure, preferably for the minimum gluing time recommended by the glue manufacturer, on the inside of the tube;
(f) removing the device from inside the tube, and checking the operation of the sensors/transductors, and protecting them with epoxy resin.

11. METHOD, according to claim 9, characterized in that the extension tube (6) is preferably made of aluminum, with a length defined from the distance from the tip of the tube to be cleaned to the region where cleaning will be performed.

12. METHOD, according to claim 9, characterized in that the rotation means comprise a drill coupled to a magnetic base.

13. METHOD, according to claim 9, characterized by the sensor/transductor elements, with the terminals welded to the cable and with cyanoacrylate glue on its surface to adhere to the inside wall of the tube.
